(19) United States
(12) Patent Application Publication
(10) Pub. No.: US 2007/0147187 A1
(43) Pub. Date: Jun. 28, 2007

(54) Method of using graphite for making hydrophilic articles

(76) Inventors: Gennady Resnick, Windsor, CT (US); Glenn M. Allen, Vernon, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/320,517

(22) Filed: Dec. 28, 2005

(51) Int. Cl. B32B 9/00; C09C 1/44; G11B 11/00

(52) U.S. Cl. 369/13.01; 428/408; 106/472

(57) ABSTRACT

A water transport plate assembly that is useful in fuel cells includes at least one hydrophilic article such as a flow field layer. A method of making the hydrophilic article includes establishing a hydrophilicity of the article by including a plurality of graphite particles (112) having a particular physical characteristic that imparts the hydrophilicity to the article. In one disclosed example, the selected graphite particles (112) have a wettability ratio of a hydrophilic surface area to a total surface area that is sufficient to make the article hydrophilic. In a disclosed example, the wettability ratio is more than 0.10. In a disclosed example, the graphite particles are selected based upon a percentage of prismatic surface area of the total surface area.

### FIELD OF THE INVENTION

This invention generally relates to manufacturing hydrophilic articles. More particularly, this invention relates to using graphite as a source of wettability of a hydrophilic article.

### DESCRIPTION OF THE RELATED ART

A variety of situations require hydrophilic articles. One example is within the fuel cell art. Many fuel cell arrangements include water transport plates for controlling water, air and fuel flow within a fuel cell assembly in a known manner. Traditionally, water transport plates have included porous, hydrophilic flow fields that include flow channels for directing fluid in a desired manner. Many such flow fields comprise graphite, a resin and a wettability component. For example, it is known to treat porous graphite plates with a metal oxide post-treatment to impart wettability to the plate. It is also known to add a metal oxide as one of the components for making a water transport plate. Another example includes adding hydrophilic carbon black. In many of those instances, the wettability component is added as a separate component in a mixture containing resin such that the resin binds the wettability component in place. There is no effect on the graphite, itself, using the traditional approach.

U.S. Pat. No. 5,942,347 shows one example technique where a porous bi-polar separator plate has at least one electronically conductive material, at least one resin and at least one hydrophilic agent. Each of these components is substantially uniformally distributed throughout the separator plate of that document. The hydrophilic agent in that document is selected from material such as oxides of Ti, Al, Si and mixtures of them. There are at least two difficulties with this approach. First, it is very difficult to uniformly distribute materials as suggested in that patent. Secondly, because the oxides are dielectric, using hydrophilic or wetting agents of the type described there can increase the electrical resistance of such a separator plate, which is undesirable. Therefore, it is difficult to achieve uniform distribution as suggested in that document without increasing electrical resistance.

Such wettability treatments or additives have been required because the graphite is generally hydrophobic. Without the wettability agent or treatment, traditional graphite based water transport plates are hydrophobic and not suitable for their intended use. Graphite particles comprise carbon atoms arranged in a manner that typically provides a relatively low surface energy such that the graphite particles are essentially hydrophobic. Carbon atoms within a graphite crystal are arranged in a plurality of generally parallel planes. The bonds between the carbon atoms within the planes are very strong. Graphite particle surfaces that are aligned with such planes (i.e., basal plane surfaces) have a relatively low surface energy.

It is desirable to provide an improved process for making hydrophilic articles such as water transport plates. For example, it would be useful to make the fabrication process less complicated and to reduce costs by taking a different approach that does not include the traditional wettability additives or wettability enhancing agents. This invention addresses that need.

### SUMMARY OF THE INVENTION

An exemplary method of making a hydrophilic article includes establishing a hydrophilicity of the article by including a plurality of graphite particles having wettability ratio of a hydrophilic surface area to the total surface area that is within a range sufficient to make the article hydrophilic.

In one example, the wettability ratio is more than about 0.10. In another example, the wettability ratio is more than about 0.18.

Another example method of making a hydrophilic article includes using a plurality of graphite particles each having at least one hydrophilic surface establishing at least about 10% of a total surface area of each of such particles for establishing the hydrophilicity of the article.

In one example, prismatic surfaces on the graphite particles are hydrophilic and used as the primary hydrophilic surface for establishing the desired hydrophilic percentage of the total surface area for such particles. One such example includes generally spheroidal graphite particles. Another example includes expanded graphite. In another example, a modified basal surface is at least partially hydrophilic and constitutes a portion of the hydrophilic percentage of the total surface area for such particles. One such example includes pretreated graphite having an altered basal surface that renders that surface at least partially wettable.

Including graphite particles having surface characteristics according to each of the just-described examples introduces a sufficiently high surface energy for at least those graphite particles that the resulting article has a sufficient hydrophilicity to be considered hydrophilic. One advantage to using such graphite particles includes achieving a desired hydrophilic article in which a wettability enhancer or wettability agent need not be added. This provides the advantage of simplifying the manufacturing process and reducing expenses by reducing the number of required materials, for example.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates an example water transport plate assembly including a hydrophilic structure designed according to an embodiment of this invention.

FIG. 2A schematically shows a feature of a crystal structure of an example graphite particle.

FIG. 2B schematically shows another view of the crystal structure of FIG. 2A.

FIG. 3 schematically illustrates an example manufacturing process.

FIG. 4 schematically illustrates a portion of an example article made from the example process of FIG. 3.

### DETAILED DESCRIPTION

This invention provides a unique approach to making hydrophilic articles using graphite without requiring a wettability agent. By appropriately selecting graphite particles or pretreating the graphite particles, a desired wettability ratio for at least some of the graphite particles within an article establishes a hydrophilicity or wettability for that article. Various techniques are disclosed in this description for establishing a wettability ratio between a hydrophilic surface area and a total surface area for graphite particles that renders an article including those particles hydrophilic.

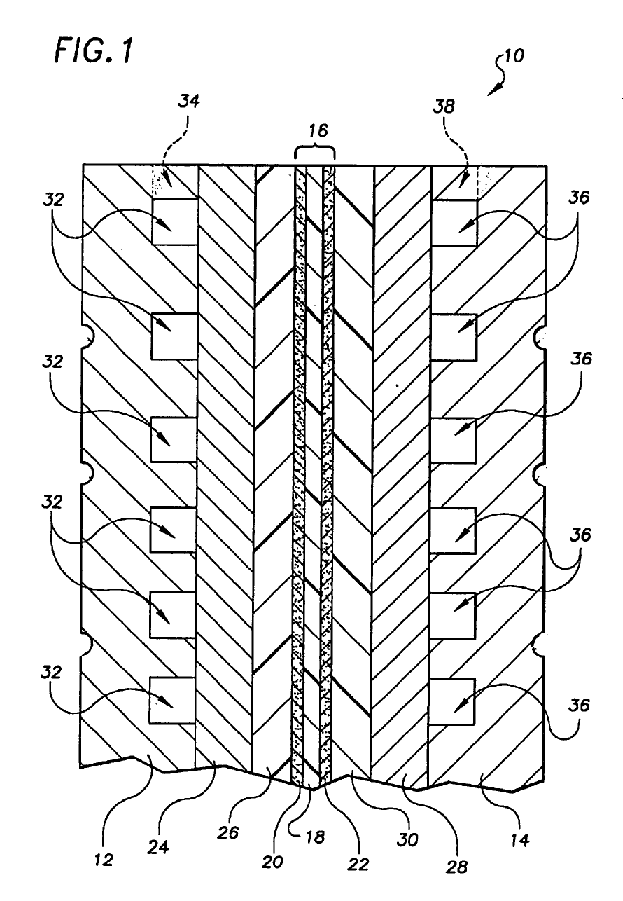

One example use of such an article is in a fuel cell. FIG. 1 shows a schematic, cross-sectional representation of an electrochemical cell such as a fuel cell 10 for generating electrical energy from process oxidant and reducing fluid reactant streams. The example fuel cell 10 has a porous carbon body comprising a first or anode water transport plate 12 and a second or cathode water transport plate 14. The anode and cathode water transport plates 12, 14 are at opposed sides of the membrane electrode assembly 16, which includes a membrane electrode assembly 16 that consists of an electrolyte such as a proton exchange membrane 18, an anode catalyst 20 and a cathode catalyst 22.

The anode water transport plate 12 includes a plurality of fuel flow channels 32 that are in fluid communication with each other and with a fuel inlet 34 that receives the reducing fluid so that the fuel inlet 34 and flow channels 32 cooperate to pass the reducing fluid fuel through the fuel cell 10 in fluid communication with the anode catalyst 20. Similarly, the cathode water transport plate 14 includes a plurality of oxidant flow channels 36 that are in fluid communication with each other and with an oxidant inlet 38 that receives the process oxidant so that the oxidant inlet 38 and oxidant flow channels 36 cooperate to pass the process oxidant through the fuel cell 12 in fluid communication with the cathode catalyst 22.

Water transport plates serve many functions in a fuel cell. Namely, they deliver reactants to membrane electrode assembly catalysts; transport product water away from the cathode to prevent flooding; humidify the anode and/or cathode reactant streams; provide a wet seal barrier between reactants and/or coolants; and act as an electrical conductor to carry electrical current to the collectors. Accordingly, the pore structure must be designed to provide the desired capillary action and assure sufficient hydrophilicity to facilitate water movement. Some arrangements include porous and non-porous sections, but the porous sections must have sufficient hydrophilicity. As mentioned above, the traditional approach for making water transport plates renders them hydrophobic unless a wettability agent has been incorporated as a raw material ingredient in the manufacturing process or in a post-treatment process.

There are other articles for which wettability and water transport properties are required. For example, some fuel cell applications utilize evaporative cooling. Some portions of such fuel cell arrangements require sufficient wettability to accomplish the desired water transport from the liquid zone to the evaporative zone.

The hydrophilicity of an object is a surface property characteristic that describes wetting behavior, which is the interaction of a liquid with a solid. For example, wetting is observed in the spreading of a liquid over a surface, in penetration of a liquid into a porous medium, or in displacement of one liquid by another. Wetting refers to the macroscopic manifestation of molecular interaction between liquids and solids in direct contact at the interface between them. Increased wettability ensures uniform spreading of a liquid over a solid surface or better penetration of a liquid through a porous medium, for example.

Wettability is typically determined by the balance between adhesive forces between the liquid and solid and cohesive forces in the liquid. Adhesive forces cause a liquid drop to spread. Cohesive forces cause the liquid drop to remain balled up.

The contact angle between the liquid and the solid is determined by competition between the adhesive and cohesive forces. When a surface is wettable or hydrophilic, the contact angle with water is less than 90°. Hydrophilic materials possess high surface energy values and the ability to form “hydrogen bonds” with water. By contrast, hydrophobic or non-wettable materials have little or no tendency to absorb water so that water tends to “bead up” on the surface in the form of discrete droplets. The contact angle with water for hydrophobic surfaces is greater than 90°. Hydrophobic materials possess low surface energy values and lack active groups in the surface chemistry for forming “hydrogen bonds” with water.

For purposes of understanding the wettability of graphite, it is useful to consider its structure. Graphite is composed of infinite layers of carbon atoms arranged in the form of hexagons (or rings) lying in planes. The layers are stacked parallel to each other. Each carbon atom within the plane is covalently bonded (e.g., is tightly bound) to three other carbon atoms. The atoms in alternative planes align with each other and are loosely bonded by van der Waals forces.

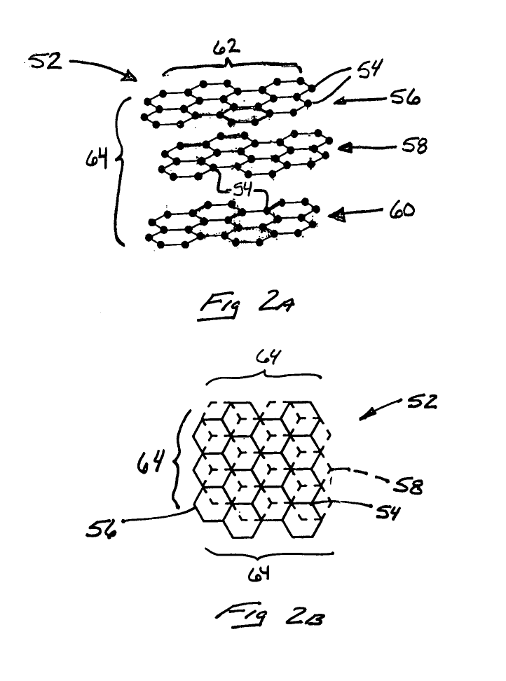

FIGS. 2A and 2B schematically illustrate an example crystalline structure of a portion of an example graphite particle 52. A plurality of carbon atoms 54 are arranged into a plurality of hexagons that lie within a plurality of planes. The illustration includes a first plane 56, a second plane 58 and a third plane 60. The covalent bonds between the carbon atoms 54 within the planes are very strong. The bonds between carbon atoms of one plane and carbon atoms of another plane, on the other hand, are much weaker.

Surface areas on the graphite particle aligned with the planes (e.g., generally parallel to the first plane 56) are referred to as a basal plane surface such as that schematically shown at 62. Ideal basal plane surfaces, which means defect free and contamination free, are homogenous, generally “smooth” and consist only of carbon atoms. Each graphite particle will have at least one basal plane surface 62 and at least one prismatic surface 64. The usual shape of graphite powder is platelets or flakes with basal sites that have a low surface energy. Flake graphite has a majority of the overall graphite particle surface area within a basal plane surface.

The strong bonds between the carbon atoms 54 within the basal planes yields a relatively low basal plane surface energy and a resulting hydrophobic surface.

The relatively weaker bonds (from van der Waals forces) between carbon atoms in different planes provides a higher surface energy along prismatic surfaces 64. The prismatic surfaces are distinguishable from basal plane surfaces 62 because the prismatic surfaces are arranged at least partially oblique to the orientation of the planes 56, 58 and 60, for example. It is sufficient for purposes of discussion to understand that normally there is a different surface energy on the basal plane surfaces 62 compared to the surface energy on the prismatic surfaces 64.

The relatively weak links between carbon atoms along the prismatic surfaces 64 and the heterogeneous nature of the prismatic surfaces (e.g., prismatic surfaces typically include various, mostly oxygen-containing functional surface groups along with the carbon atoms) gives the prismatic surfaces 64 a higher surface energy. The prismatic surface 64 can be considered a polar surface. As a result, the prismatic surfaces 64 are hydrophilic and can form strong hydrogen bonds with water molecules.

The hydrophobic and hydrophilic character of the graphite surfaces on a graphite particle can be characterized by a wettability ratio, which can be expressed by the following relation:

$$Wettability Ratio = \frac{\text{The hydrophilic surface area}}{\text{The total surface area}}$$

According to this definition, the wettability ratio can vary significantly: from almost one (for theoretical, ideal, perfectly sphere shaped graphite which has all surface area formed by the prismatic surfaces) to a very low value for graphite with predominantly basal plane surface. The higher the wettability ratio of graphite, the better its wettability.

In one example, the wettability ratio equals the ratio of prismatic surface area to the total surface area.

Prismatic (e.g., hydrophilic) surface area and total surface area can be determined experimentally. The hydrophilic (and hydrophobic) character of graphite surfaces can be determined by absorption calorimetry, or by flow microcalorimetry. The total surface area can be determined by the Brunauer, Emmett and Teller (BET) method. A very exact method useful in breaking down the total surface area of graphite into fractions of basal plane surfaces and prismatic surfaces is krypton gas absorption.

The relative hydrophilicity between differing graphites can be determined using known techniques such as the Washburn method (or Capillary Rise Method), which is well known from published literature. This technique allows for obtaining the values of contact angles, which indicates in a relative manner whether a surface is hydrophilic (i.e., wettable) or hydrophobic.

One example embodiment of this invention includes the realization that increasing the amount of prismatic surface area within graphite used for forming a hydrophilic article establishes sufficient wettability for the article to meet the hydrophilicity needs of a particular situation. It has been found, for example, that using sufficiently wettable graphite particles as at least a portion of the graphite used to make the article can establish a sufficient wettability to meet the needs for many fuel cell applications.

One example includes selecting graphite particles having a wettability ratio, which is the ratio of the hydrophilic surface area to the total surface area, within a range sufficient to make the resulting article hydrophilic. In other words, selecting enough of the graphite particles to have a particular physical characteristic results in enough wettable (e.g., prismatic) surface area compared to the hydrophobic (e.g., basal plane) surface area to render the resulting article hydrophilic. By appropriately selecting graphite particles, the wettability of a hydrophilic structure can be established purely by the graphite particles.

In one example, the selected graphite particles have a wettability ratio that is more than about 0.10. This is achieved in one example, by selecting graphite particles that have at least about 10% prismatic surface area with a remaining percentage basal surface area.

One example includes selecting graphite particles having a wettability ratio greater than 0.18. In this example, provided that there are enough graphite particles having at least about 18% wettable (e.g., prismatic) surface area, sufficient wettability can be obtained for many fuel cell water transport plate applications. One example includes selecting graphite particles that are generally spheroidal. Such particles have more prismatic surface area than flake graphite. One particular example includes spheroidal graphite particles as the majority of the graphite. Another example includes spheroidal graphite particles, exclusively. Strategically controlling the amount and type of graphite particles that are included will provide wettability in an amount sufficient to meet the needs of a given situation.

A variety of commercially available spheroidal graphite materials are known. Prior to this invention, however, no one has considered the wettability aspects of such particles. Instead, they have been always used with a wettability agent. U.S. Pat. No. 6,746,982, for example, mentions the use of Timcal KS75 and KS150 graphite, both of which are spheroidal. That patent teaches adding a wettability treatment. U.S. Pat. No. 6,926,995 suggests using natural or synthetic graphite for a porous separator plate and teaches that the graphite is not subject to any particular limitation. That patent is another example of the traditional thinking that adding a hydrophilic agent is necessary to achieve wettability.

Wettability agents typically have been introduced along with resin and graphite particles. In those instances, wettability agents have been secured to the structure or made part of the structure by the binding action of the resin. In other words, the wettability agents did not directly impact the graphite because they were present within the composite and typically held in position by the resin.

As mentioned above, one example implementation of this invention includes using generally spheroidal graphite particles because of their relatively higher percentage of prismatic surface area compared to flake graphite, for example. Another example includes using expanded graphite particles to achieve the desired wettability ratio. Expanded graphite particles are known. Expanded graphite particles have larger distances between the parallel plane of carbon atoms, which provides an increased prismatic surface area compared to non-expanded graphite particles. One embodiment of this invention includes using at least some expanded graphite particles within the graphite to provide hydrophilicity to a resulting article.

Another example includes a pretreated graphite that has increased wettable surface area compared to pure or untreated graphite. In one example, the basal plane surface of the pretreated graphite has some wettability along with the wettability of the prismatic surfaces such that a higher percentage of hydrophilic surface area exists compared to pure or untreated graphite.

One example includes treating the basal surfaces of the graphite to create defects on the basal planes using a plasma, laser or other surface treatment. Defects on the basal planes will interrupt or interfere with the otherwise present strong covalent bonds between the carbon atoms, which will increase the surface energy and the wettability of a basal surface. In such an example, at least some of the basal plane surface area can be considered as part of the hydrophilic surface area along with the already hydrophilic prismatic surface area.

Another example includes using a deposition process to effectively modify the basal surface of graphite particles prior to forming a hydrophilic article. In one example, pure graphite is mixed with an organic titanate in an ethanol solution. One example includes using Tyzor® (tetra n-butyl titanate (TnBT)), which is available from Dupont. In one example, the amount of titania (TiO₂) constitutes 0.4-0.5 mass % of the graphite.

Organic butyl titanate solution is mixed with a solvent (ethanol) and graphite. The butyl titanate and solvent react with the graphite resulting in TiO₂ being deposited on the basal plane surface of the graphite by means of the room-temperature decomposition of the butyl titanate. Upon heating the slurry, further deposition is accomplished. A complete loss of organic components occurs at 350° C.

When such an organic butyl titanate solution is heated, ethanol will be evaporated and butyl titanate will be decomposed into TiO₂ by the following reaction:

Ti(OC₄H₉)₄==>TᵢO₂+4C₄H₈+H₂O

The result is the presence of TiO₂ on surfaces of the graphite particles. The deposited TiO₂ on the graphite particles renders those surfaces at least partially wettable. We believe the presence of unsaturated Ti atoms, which can be easily combined with oxygen atoms in water to form Ti—OH layers, renders such a surface hydrophilic or wettable. On some surfaces, 2-3 layers of physically absorbed water are further formed.

From one perspective, pretreating graphite as described above increases the surface energy of the surfaces where the TiO₂ is deposited. In some example embodiments of this invention, the pretreated graphite particles include basal plane surfaces with a higher surface energy compared to untreated graphite such that the pretreated basal surfaces are hydrophilic.

In one particular example, 25 g of graphite powder KS5-75TT (d90=70 micron) was added to 40 ml of an ethyl solution and mixed at approximately 1000 rpm in a 3-propeller Barnant mixer. A selected amount of Tyzor® (0.5326 g of Tyzor® TnBT 23.5 mass % TiO₂ in 25 g of graphite) was dissolved into 5 ml of the ethanol solution and added to the graphite slurry. The mixture was stirred for fifteen minutes and placed in a large glass dish. That was then placed into a nitrogen purged oven in which the temperature was slowly ramped to 200° C. at a rate of 10° C. per minute. The graphite resided isothermally at 200° C. for 20 minutes and then the temperature was ramped to 350° C. at a rate of 10° C. per minute. In this example, the temperature of 350° C. was maintained for 10 minutes before turning off the oven and letting it cool down slowly to room temperature.

In one example, deposited TiO₂ was examined qualitatively using Energy Dispersive Spectroscopy (EDS) and quantitatively by Inductively Coupled Argon Plasma (ICP). The EDS results confirmed the presence of TiO₂ on the graphite and the ICP results demonstrated that the amount of TiO₂ was close to 0.5 mass % of graphite. The surface morphology of the deposited TiO₂ was characterized using Scanning Electron Microscopy (SEM). White deposits of TiO₂ were seen on the basal plane surface of graphite particles and their estimated dimensions were in a nanometer range.

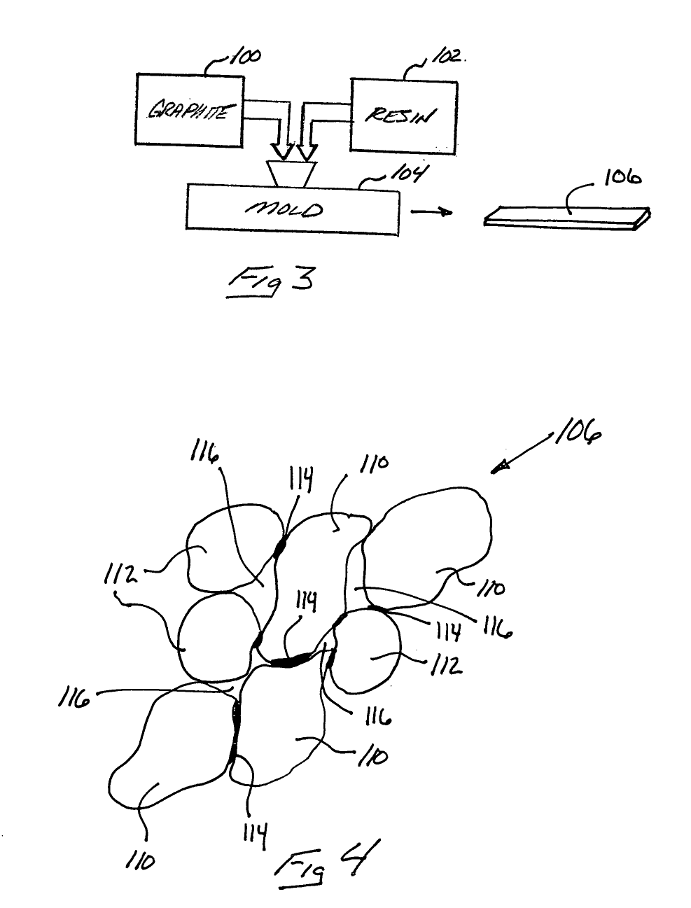

FIG. 3 schematically shows one example technique of making a hydrophilic article designed according to an embodiment of this invention. A graphite supply 100 includes a plurality of graphite particles having a wettability ratio of a hydrophilic surface area to a total surface area that is within a range sufficient to make the article hydrophilic as discussed above. In one example, the included plurality of graphite particles are generally spheroidal. In another example, the plurality of included graphite particles comprise expanded graphite. In still another example, the included plurality of graphite particles comprise pretreated graphite having an altered basal plane surface that is hydrophilic. One example comprises a basal plane surface including TiO₂ deposits.

The graphite from the supply 100 is mixed with a resin 102 and a mold 104 is used to form a resulting article 106. FIG. 4 schematically shows a portion of the resulting article 106. In the example of FIG. 4, the article is porous and includes some graphite particles that are traditional flake graphite shown at 110 and other graphite particles that have a wettability ratio that is within a range sufficient to make the article hydrophilic. These graphite particles are shown at 112. The resin from the supply 102, which binds together graphite particles, is schematically shown at 114. Voids or passages 116 exist between graphite particles, which renders the resulting article porous. In one example, the wettable surface of the graphite particles 112 is adjacent to or within the voids or passages channels 116.

Depending on the performance characteristics required for the resulting article and the type of graphite selected for forming the article, different wettability ratios will provide the intended results for different operating conditions. Given this description, those skilled in the art will be able to select appropriate wettability ratios and percentages of appropriate graphite particles within the graphite to provide a hydrophilic article that meets their particular needs without requiring a wettability agent or additive in the graphite-resin mixture.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of making a hydrophilic article, comprising
establishing a hydrophilicity of the article by including a plurality of graphite particles having a wettability ratio of a hydrophilic surface area to a total surface area that is within a range sufficient to make the article hydrophilic.

2. The method of claim 1, wherein the included plurality of graphite particles provides the only source of the hydrophilicity.

3. The method of claim 1, wherein the wettability ratio is more than about 0.10.

4. The method of claim 3, wherein the wettability ratio is more than about 0.18.

5. The method of claim 1, wherein the wettability ratio equals a ratio of a prismatic surface area to a total surface area.

6. The method of claim 1, wherein the plurality of graphite particles are generally spheroidal.

7. The method of claim 1, wherein the plurality of graphite particles comprise expanded graphite.

8. The method of claim 1, wherein the hydrophilic article comprises a plate adapted for use in a fuel cell.

9. The method of claim 1, wherein the hydrophilic article is porous.

10. A hydrophilic article made by the process, comprising
establishing a hydrophilicity of the article by including a plurality of graphite particles having a wettability ratio of a hydrophilic surface area to a total surface area that is within a range sufficient to make the article hydrophilic.

11. The hydrophilic article of claim 10, wherein the included plurality of graphite particles provides the only source of the hydrophilicity.

12. The hydrophilic article of claim 10, wherein the wettability ratio is more than about 0.10.

13. The hydrophilic article of claim 12, wherein the wettability ratio is more than about 0.18.

14. The hydrophilic article of claim 10, wherein the wettability ratio equals a ratio of a prismatic surface area to a total surface area.

15. The hydrophilic article of claim 10, wherein the plurality of graphite particles are generally spheroidal.

16. The hydrophilic article of claim 10, wherein the plurality of graphite particles comprise expanded graphite.

17. The hydrophilic article of claim 10, wherein the hydrophilic article comprises a plate adapted for use in a fuel cell.

18. The hydrophilic article of claim 10, wherein the hydrophilic article is porous.

19. A method of making a hydrophilic article, comprising
establishing a hydrophilicity of the article by including a plurality of graphite particles each having the at least one wettable surface establishing at least about 10% of a total surface area of each of the included plurality of the graphite particles.

20. The method of claim 19, wherein the included plurality of graphite particles each have a wettability ratio between a hydrophilic surface area and a total surface area that is more than about 0.10.

21. The method of claim 20, wherein the wettability ratio is more than about 0.18.

22. The method of claim 19, wherein the included plurality of graphite particles provide the only source of the hydrophilicity.

23. The method of claim 19, wherein the included plurality of graphite particles comprise at least one of generally spheroidal graphite particles or expanded graphite.

24. The method of claim 19, wherein the at least one wettable surface comprises a prismatic surface.

25. The method of claim 24, wherein the wettability ratio equals a ratio of a prismatic surface area to the total surface area.

26. The method of claim 19, wherein the hydrophilic article comprises a plate adapted for use in a fuel cell.

27. The method of claim 19, wherein the hydrophilic article is porous.
